(19) United States
(12) Patent Application Publication
(10) Pub. No.: US 2024/0279770 A1
(43) Pub. Date: Aug. 22, 2024

(54) SEQUENTIAL TREATMENT PROCESS FOR THE HEAP LEACHING OF PRIMARY AND SECONDARY COPPER SULPHIDES

(71) Applicant: CORPORACION NACIONAL DEL COBRE DE CHILE, Santiago (CL)

(72) Inventors: Felipe LAGNO SÁNCHEZ, Santiago (CL); Carolina SALHE LEIVA, Santiago (CL); Héctor CARREÑO NAVARRO, Santiago (CL); Héctor JORDAN GUTIÉRREZ, Santiago (CL)

(21) Appl. No.: 18/290,218

(22) PCT Filed: May 12, 2022
(86) PCT No.: PCT/CL2022/050050

§ 371 Date: Nov. 10, 2023

(30) Foreign Application Priority Data
May 12, 2021 (CL) 1250-2021

(51) Int. Cl. C22B 15/00; C22B 3/04; C22B 3/08

(52) U.S. Cl. CPC C22B 15/008; C22B 3/04; C22B 3/08; C22B 15/0071

(57) ABSTRACT

A sequential treatment process for primary and secondary copper sulphide heap leaching such as Chalcopyrite, Bornite, Chalcosine, Coveline or other sulfide and mixed copper ores is provided. Specifically, the treatment process consists of a sequential treatment of crushed ore with size p80 less than 38 mm, preferably under 19 mm, which is arranged in a dynamic heap or primary leaching heap, in which once leached in the dynamic heap, the ore is removed from the heap and transferred to a new heap to be subjected to a secondary leaching process in a permanent heap, where the leaching process in all its stages is carried out under increased concentrations of chlorine ion, [Cl⁻]>40 g/L, which improves the thermodynamics and physic-chemical balances that the solutions of the process are established, which generates important benefits on the metallurgical performance of this sequential treatment.

### SPECIFICATION

The present application of invention patent is directed to a sequential treatment process for heap leaching of primary and secondary copper sulphides such as Chalcopyrite, Bornite, Chalcosine, Coveline or other sulfide and mixed copper ores. Specifically, the treatment process consists of a sequential treatment of crushed ore with size p80 less than 38 [mm] (preferably under 19 [mm]), which is arranged in a dynamic heap or primary leaching heap, in which once leached in the dynamic heap, the ore is removed from the heap and transferred to a new heap to be subjected to a secondary leaching process in a permanent heap, where the leaching process in all its stages is carried out under increased concentrations of chlorine ion, [Cl⁻]>40 g/L, which improves the thermodynamics and physic-chemical balances that the solutions of the process are established, which generates important benefits on the metallurgical performance of this sequential treatment.

### PRIOR ART

Chemical activity is a well-known but generally poorly understood aspect. In very simple terms, chemical activity can be thought of as the “actual concentration” of some species in a solution. Activity coefficients (defined as the coefficient by which the actual concentration is multiplied to obtain activity) in chloride salts have mostly higher values than those present in the corresponding sulfate salts. For most sulfate salts in solution, the average activity coefficient (γ±) decreases sharply as the molality, m (defined as kg of solute per kg of solvent, and not to be confused with the molarity, M, defined as the number of moles of solute per liter of solution), increases from the ideal value of 1.0 in very dilute solutions, as low as 0.05. In contrast, the value of γ± for the chloride equivalent salt typically passes through a minimum of about 05, at a concentration of about 0.5, and then increases to greater than 10M in highly concentrated chloride solutions. Raising the temperature decreases the activity of HCl, presumably because the structure of the water decomposes at increased levels of temperatures that make the water more basic. However, this increase in activity is still very considerable.

The increase in HCl activity has been studied for quite a few years, in particular its variation when salts such as NaCl, CaCl2 or MgCl2 are added to dilute HCl solutions. For example, in the document “Direct leaching of sulfides: Chemistry and applications” (Peters, 1976), it was estimated that the activity of 2 m HCl in 3 m MgCl2 or 3 m CaCl2 is equal to the activity of 7 m HCl, with the increase in HCl reactivity being a function of the Cl concentration. Likewise, in the document “Measurement of the activity of electrolytes and the application of activity to hydrometallurgical studies” (Majima and Awakura, 1981), it was noted that the activity of 1 m HCl is 3 times higher in 1 M NaCl and 20 times higher in 3M NaCl than in the absence of added salt. Similarly, 2M HCl activity increases to 50 in 3M NaCl or 1.5M CaCl2, as shown in FIG. 2. The activity of water (a_{w}) which is 1 by definition decreases with an increase in the concentration of the electrolyte as a result of ion-water interactions, the activity of water decreases with the addition of HCl and other chloride salts.

Regarding the physicochemistry of chlorinated solutions, specifically in Cu(II):Cu(I) and Fe(III):Fe(II) species, hydrometallurgical processes in chloride medium take into consideration the oxidizing capacity of the Fe(III) and Cu(II) ions for the oxidation of metal sulfides to elemental sulfur and the high stability of the chloride metal complexes in solution. In the document “The dissolution of chalcopyrite in chloride Solutions Part 3” (Miki and Nicol, 2010), it is suggested that the presence of chloride ions forms complexes with copper and iron stabilizing Cu(I) and allowing Cu(II) to act as an oxidant. At the same time Cu(I) can react with Fe(III) generating more Cu(II) and Fe(II). Fe(II) is then re-oxidized to Fe(III). This is highly dependent on the concentration of chloride ([Cl]>3M). These works suggest that both ions participate in the oxidation reactions. However, the leaching capacity of the cupric ion is higher than that of the ferric ion, since the cupric ion tends to regenerate more easily in the presence of oxygen and ferric ion.

The ion speciation results, for environments commonly found in hydrometallurgical operations, confirm that the dominant species of ferric and ferrous ions are FeCl²⁺ and hydrated Fe²⁺. For [Cl]<0.5 M, hydrated Cu²⁺ and CuCl²⁺ are the predominant ionic species for the cupric and cuprous species. On the other hand, at 0.5M<[Cl]<3M, CuCl⁺ and CuCl²⁻ are the dominant species for cupric and cuprous ions respectively.

Regarding the non-oxidizing/oxidizing solution of chalcopyrite, the mechanism has been proposed by different researchers in the literature and would be represented in the following chemical reactions:

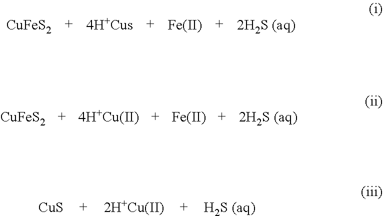

The H₂S(aq) generated by the above reactions would be rapidly oxidized, in the presence of Cu(II), Fe(III) ions and the presence of oxygen according to:

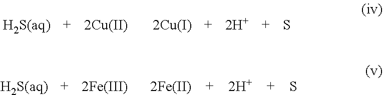

The first advantage of salt thermal rest is that it is carried out under high Cl concentration, and it is well reported in the literature the effect it has on the activity of the H⁺ ion (aH+) and the formation of Cl—Cu complexes, allowing and favoring reactions (i), (ii), (iii), that is; the non-oxidizing acid solution, followed by the oxidation of S₂⁻.

As the temperature is increased the dissolution of the copper sulphide ores is controlled kinetically by the chemical reaction. At higher temperatures, dissolution requires low activation energy to break the bonds of the molecules and therefore produces more soluble mineralogical species. In addition, high concentrations of chloride in solution allow the cuprous ion, Cu(I), to be thermodynamically stable by the formation of Cl—Cu(I) complexes in solution allowing—from a thermodynamic point of view—reaction (v) and at least partially the following reactions:

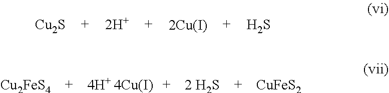

Document CL 2007-1356 describes a hydrometallurgical process for recovering copper in ponds from copper sulphide ores such as bornite, chalcosine, chalcopyrite, coveline and enargite. Leaching is carried out in the presence of dissolved oxygen and the potential of the ore surface is maintained below 600 mV (vs. SHE). The method includes the steps of leaching the ore into an acid chloride pulp or mixed chloride/sulfate pulp, in the presence of dissolved oxygen, maintaining the potential of the surface of the ore as already indicated, to cause the dissolution of the copper sulfide from the pulp.

The difference with respect to the present invention lies in that document CL 1356-2007 does not describe a process in which a treatment in stages to copper sulfide is carried out, so as to favor an activation of the ore in a thermal rest stage and a subsequent leaching under a non-oxidizing mechanism.

Registration CL 48.695 describes a method for recovering copper from a ore, in a heap, containing a copper sulphide ore, comprising the steps of leaching the ore with a leach solution containing acid chloride or with a mixed leach solution composed of chloride/sulphate, in the presence of dissolved oxygen and maintaining the solution potential at the surface of the ore within a range of 550 mV to 600 mV because the Cu(II)/Cu(I) ratio in the leach solution is controlled, to cause dissolution of the copper sulphide ore, and recovering copper from the solution. This document differs from the application because it does not describe a process in which a treatment is carried out in stages to copper sulfide, so as to potentially favor an activation of the ore in a thermal rest stage and does not include a step to control the Cu(II)/Cu(I) ratio.

Document CL 2015-3477 describes a method of leaching copper from a ore heap that is irrigated with a leach solution, including at least one rest stage followed by an leaching stage, wherein during the leaching stage a leach solution containing chloride ions is applied to the ore at a higher rate than during the rest stage, and during the leaching stage the chloride ion concentration of the leach solution is between 100 grams per liter and 190 grams per liter, and wherein the rest stage has a duration of 20 hours to 50 days in order to increase the dissolution of the ore. This document differs from the present invention because it does not describe a sequential procedure that contemplates a primary leaching stage of ore: oxidizing chemical; in which then a stage of excavation of gravel is carried out and addition of saturated brine on a belt, to then let the gravel rest, this new rest allows the acid and chloride to be in greater contact with the gravel to react with the ore (gravel) resulting in a greater solid-liquid interaction time. To finally carry out a secondary leaching stage of gravel: oxidizing chemical.

Document CL 2016-1188 describes a four-stages process that contemplates the addition of recirculated solution in the agglomeration process; addition of heat to the primary sulfide ore and/or the solution in the curing stage with a temperature greater than 30° C. and less than 60° C.; addition of heat to the ore or heating of solutions in the heap leaching stage with solution containing recirculated solution at a temperature greater than 30° C. and less than 60° C.; and washing in heaps with refining solution following the previous heap leaching process. This document differs from the invention because it does not describe a sequential process that contemplates a primary ore leaching stage: oxidizing chemical; in which a stage of excavation of gravel and addition of saturated brine on a belt are then carried out, to then let the gravel rest and finally carry out a secondary gravel leaching stage: oxidizing chemical.

Another fundamental difference with respect to the CL 2016-1188 patent is that, during the first rest, a temperature increase is made, with external sources—heated and supersaturated air—to ensure a first thermal rest at a high temperature.

The fundamental advantage of the present invention is that a sequential treatment process is carried out for primary and secondary copper sulphide heap leaching such as Chalcopyrite, Bornite, Chalcosine, Coveline or other sulfide and mixed copper ores, in which it is arranged in a dynamic heap or primary leaching heap with a first stage of thermal rest in which once leached in the dynamic heap, the ore is removed from the heap and transferred to a new heap to be subjected to a secondary leaching process in a permanent heap, where the leaching process in all its stages is carried out under increased chloride concentrations, [Cl]>40 g/L, which strongly impacts the thermodynamics and the physicochemical balances that the process solutions are established, which generates surprising important benefits on the metallurgical performance of this sequential treatment.

### BRIEF DESCRIPTION OF THE DRAWINGS

FIG. 1: represents an illustrative view of the sulphide treatment process of the invention.

FIG. 2: represents a graph of HCl activity as a function of chlorine concentration (Majima & Awakura, 1981).

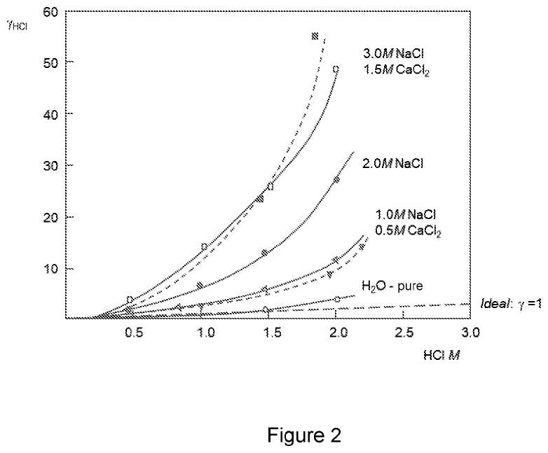

FIG. 3: Kinetic curves of copper extraction, copper primary sulfide ore.

FIG. 4: Kinetic curves of copper extraction in the sequential process of primary leaching and (initial rest), chalcopyrite ore.

### DESCRIPTION OF THE INVENTION

The invention consists of a sequential treatment process for primary and secondary copper sulphide heap leaching such as Chalcopyrite, Bornite, Chalcosine, Enargite or other sulfide ores, which comprises a treatment in stages to copper sulfide, so as to favor an activation of the ore under a non-oxidizing-oxidizing mechanism where the aqueous medium is adjusted to high concentrations of chloride ([Cl]>1M) to considerably increase the average activity coefficient of HCl (γ±) and decrease water activity (a_{w}). The process of the invention contemplates the following stages:
a) Stage (I): Mixture of ore with acidic (unsaturated) brine (would not necessarily be saturated). (1)
b) Stage (II): Thermal Rest. (2)
c) Stage (III): Primary ore Leaching: Oxidizing chemical (3)
d) Stage (IV): Excavation of gravel and addition of saturated brine on belt. (4)
e) Stage (V): Gravel rest (5)
f) Stage (VI): Secondary Leaching of gravel: Oxidizing chemical. (6)

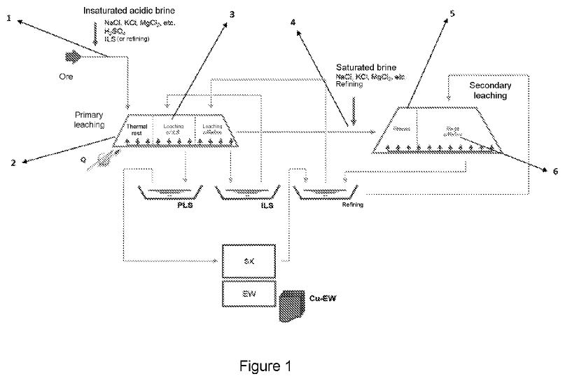

The copper produced is concentrated in PLS (pregnant leach solution) solution and extracted by known solvent extraction and electrowinning techniques. An illustrative view of the sulfide treatment process is presented in FIG. 1. The detail of each of the stages is described below:

### Stage (I): Mixture of Ore with Acidic (Unsaturated) Brine

Unsaturated acidic brine is added over a crushed copper ore. The addition is carried out in conventional systems on the ore that is transported on a belt (conveyors belt) for its arrangement in a heap of dynamic or primary leaching. The addition of brine considers the following criteria:
Obtain a moisture of the ore that is heaped between 5 to 10%—preferably 8%.
The brine should have a Cl concentration between 100 g/L and 200 g/L, preferably between 150 and 200 g/L
Cu(T) concentration per about 1.0 g/L.
Fe(T) concentration per about 1.0 g/L
Sulfuric acid is added to ensure between 30% to 80% of the ore consumption of stoichiometric sulfuric acid, H₂SO₄, from the ore

The preparation of this unsaturated or partially saturated acidic brine in chlorine (Cl) is carried out in a solution pond (stirred pond) by mixing:
Chlorine salts of the type: NaCl, KCl, MgCl₂, or any salt or brine containing high concentrations of chlorine ion.
Intermediate solution (ILS) or refining, which contains dissolved Cu and Fe ions.
Concentrated sulfuric acid

The mixture of these reagents to form the brine, in particular the incorporation of sulfuric acid could generate an increase in temperature due to the exothermic reactions that occur and this coupled with the eventual evolution of HCl(g) so a scrubber-type gas collection system, gas washing towers or the like is incorporated.

The main advantage of this brine-acid-ore contact method on belts are:
No agglomerator drum is required
Does not generate exothermic reactions on the belt
Ensures proper mixing
Controls the emission of hydrochloric gases

### Stage (II): Thermal Rest

The ore-brine mixture is arranged on folders in a dynamic leaching heap or primary leaching heap. Once the ore has been heaped, a thermal rest process is initiated that is mainly characterized by the addition of external heat by blowing heated saturated air into the bed in order to maintain and/or bring the temperature of the ore to values between 30° C. to 80° C. The flow of saturated air—in the thermal rest stage—must be greater than 0.5 Nm³/h-m², preferably greater than 1 Nm³/h-m².

The thermal rest time can vary between 10 to 60 days depending on the type of ore, but average values are between 25 to 50 days. The heap ore is covered on its surfaces and slope to avoid water losses (by evaporation) and heat in this stage of thermal rest there is no irrigation on the surface of the heap or crown, during this time the ore is covered to avoid water evaporation, it is possible to maintain a moisture of the heaped ore constant between 6 to 10%.

In practical terms, this thermal rest process is carried out with a virtually stagnant solution and it has been found that this thermal rest generates surprising benefits for the overall performance of the sulfurized copper ore leaching process, substantially improving the dissolution kinetics and recovery of copper in the overall process and the greater liquid and gaseous permeability acquired by the ore bed. Under these conditions—given the stagnation of solutions—a mechanism that would favor the acidic or non-oxidizing dissolution of the most refractory Cu sulphides.

As mentioned above, this thermal rest stage shows significant improvements in the permeability—liquid and gas—of the ore bed. This thermal rest is carried out in conjunction with a solution of high concentrations of Chlorine, [Cl]>100 [g/L], with the consequent decrease in the activity of water—a_{w}«I—[Senanayake and Muir; 2003], which inhibits the dissolution of silicates, by the chemical dehydration of these, making these phases more insoluble allowing to form better bonds between the finer clays and the ore particles. The higher temperature favors the hydrolysis of the different ions and also dehydration. This prolonged thermal rest has shown a low formation of amorphous or slightly crystalline hydroxides or oxy-hydroxides, this would be explained by the fact that during this period nucleation or transformation towards more crystalline phases would be favored, a phenomenon known as Stranki rule [Blesa and E. Matijevic, 1989]

### Stage (III): Chemical Leaching—Oxidizer

Once the thermal rest process is finished, a conventional irrigation stage is initiated, similar to those widely used in Cu hydrometallurgy, this irrigation is first carried out with an intermediate leach solution (ILS) that is characterized by having concentrations of chlorine greater than 25 [g/L] but less than 100 [g/L]. The ILS solution must also contain Cu and Fe ions in solution in order to allow the ferric and cupric leaching-oxidation of copper sulphides. At this stage it has been observed that the main dissolution of the secondary copper sulfides originally present in the ore occurs, as well as those synthetic phases that have been formed by the effect of the chemical reactions (1), (3), (7) and (8) previously described. Major chemical reactions would then be [Petersen and Dixon, 2007; Miki et al, 2010]:

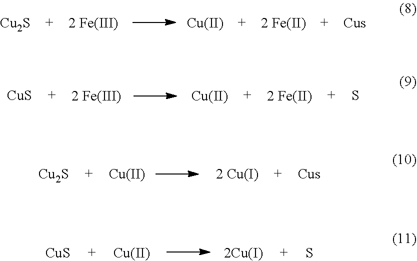

Partially, the primary copper sulfides (chalcopyrite and bornite) react with the cupric and ferric ions, according to the following probable reactions:

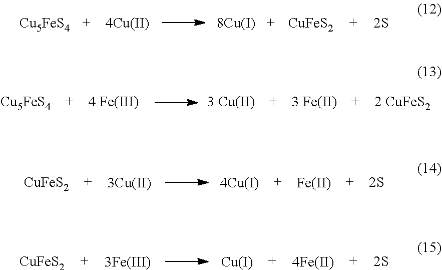

Oxidizing chemical leaching considers the aeration of the heap by means of an aeration system that is arranged at the base of the heap only above a drainage layer. The aeration rate of 0.45 Nm³/h-m², but could range between 0.15 and 0.85 Nm³/h-m² depending on the copper ore grade. This aeration is carried out to promote the oxidation of the Cu(I) and Fe(II) ions:

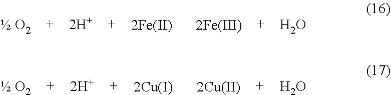

These reactions would ensure the continuous oxidation of cuprous and ferrous ions ensuring the efficient oxidation of copper sulfides (reactions 8 to 15).

The Stage (III) of oxidizing chemical leaching is carried out with a continuous irrigation of ILS solution for a period of time between 20 to 60 days, followed by an irrigation with refined solution that can be in a continuous mode or an irrigation-rest mode to allow a natural oxidation/aeration of the ore bed for a period of time between 30 to 60 days. The intermediate rest stages during this stage must be carried out again by incorporating external heat, blowing heated saturated air into the bed in order to maintain and/or increase the temperature of the ore to values between 30° C. to 40° C. In the same way as in stage II, the flow of saturated air—in the thermal rest stage—must be greater than 0.5 Nm³/h-m², preferably greater than 1 Nm³/h-m².

This stage ends with a drainage of between 3 to 10 days to decrease the moisture of the ore to a value close to 6% (percentage by weight)

### Stage (IV): Excavation of Gravel and Addition of Saturated Brine on Belt

It has been found that the process of oxidizing chemical leaching in chloride medium reaches a kind of plateau or tableland that normally occurs between 80 to 150 days once thermal rest has begun, this can be attributed to a kind of passivation of the primary sulfides (chalcopyrite). This passivation occurs by formation of a layer around the ore surface, either an elemental sulfur layer, an iron oxide layer, or a layer of a sulfide less reactive than chalcopyrite [Hackl et al. 1995; Lui et al., 2017]

During the excavation process of the leached ore or gravel, and prior to its disposal in a permanent heap or secondary leaching heap, a brine over-saturated in chlorine is added on a belt at a ratio of 0.5 to 3 kilograms of brine per ton of gravel or leached ore. The brine is prepared by mixing refining or process water and some chlorine salt (NaCl, KCl, MgCl₂, or other salt) in order to be over-saturated in chlorine, i.e. a Cl concentration between 300 to 600 g/L, preferably 500 g/L. The preparation is carried out in a stirred-sealed pond similar to that for the preparation of unsaturated brine.

### Stage (V): Gravel Rest

The gravel is deposited in a permanent heap. The process of sequential treatment of sulfides is continuous, with a new rest—not irrigation—, but in this case the rest is carried out for a time from 45 to 90 days, preferably 60 days, where similar reactions to those reported in stage II of thermal rest would occur.

### Stage (VI): Secondary Leaching of Gravel: Oxidizing Chemical

Oxidizing chemical leaching of gravel is favored by the presence of oxygen. However; an eventual aeration (between floors or basal) of the permanent heap is unprofitable, mainly due to the lower gravel grade, which is why the present invention proposes to perform a natural convection aeration by favoring an irrigation-non-irrigation mode to allow a natural oxidation/aeration of the ore bed for a period of time between 50 to 300 days.

### EXAMPLE

### Ore

As an example for this application, an ore containing mainly primary copper sulfides with a total copper grade of 0.33% was used. The copper contained in the sample can approximate: 64% in the form of chalcopyrite; 19% in the form of bornite; 7% in the form of chalcosin and 10% as chrysocolla.

The ore was crushed to 100% under 1½ inch, 80% under ¾ inch

The experimental leaching tests were carried out in tubular columns of 1 m in height and 15 cm in diameter, with a capacity for 27 kg of ore.

### Thermal Rest

In an initial stage, preconditioning, the ore was contacted with 1.6 L of an acidic brine (moisture 7%), water mixture, ILS solution, industrial salt of sodium chloride and concentrated sulfuric acid, with concentrations of total copper 1 g/L, total iron 5 g/L, acid 150 g/L and chloride 180 g/L.

The ore-brine mixture was loaded on the 1 m columns and subjected to a thermal rest between 35° C.-45° C. for 30 days.

### Oxidizing Chemical Leaching

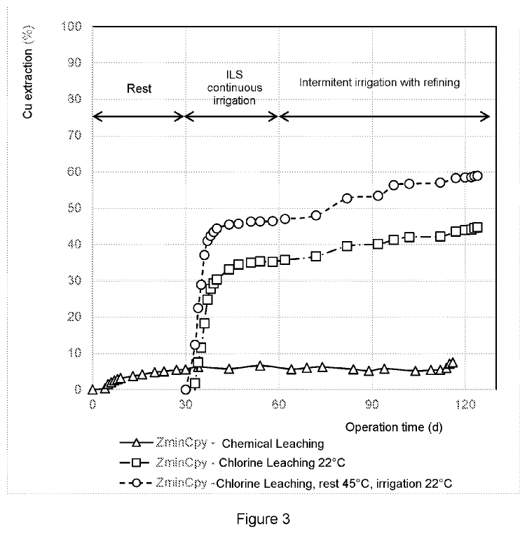

Subsequently followed by an irrigation stage with ILS solution with concentrations of total copper 1.4 g/L, total iron 5 g/L, acid 17 g/L and chloride 85 g/L, for a period of 30 days in a continuous regime, followed by an alternating irrigation with refining (total copper 0.2 g/L, total iron 5 g/L, acid 17 g/L and chloride 85 g/L) whose results are presented in the following FIG. 3

FIG. 3 included the results of two additional tests corresponding to the base case of the acid chemical leaching (without thermal rest, without the addition of brine and without chloride in the irrigation solutions) and to the case of chlorinated leaching with rest at room temperature.

These results demonstrate that by establishing a temperature between 35° C. and 45° C. during the initial rest period of the heap ore, it is possible to increase the extraction of copper with respect to the case at room temperature, both in the bornite and chalcopyrite ores.

These results demonstrate that, by establishing a higher temperature during the initial rest period of the heap ore, it is possible to increase the extraction of copper with respect to the case at room temperature.

### Secondary Leaching Stage

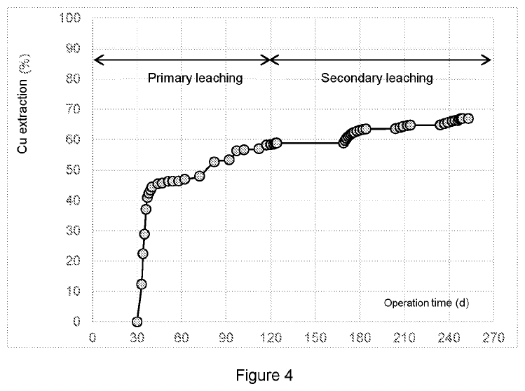

From the gravel generated in the primary leaching, 25 kg were taken where the conditions of the secondary leaching process were simulated by incorporating 90 ml of an over-saturated brine (around 500 g/L of Cl) into the gravel, with an initial rest period of 45 days followed by a period of irrigation with refining (total copper 0.2 g/L, total iron 5 g/L, acid 17 g/L and chloride 85 g/L) for 15 days in a continuous regime, followed by an alternating irrigation for 70 days, all at controlled room temperature at 22° C. and whose results are presented in FIG. 4.

These experimental results show that in a second stage of salt leach from gravel in dumps, between 7 and 9 additional points of copper extraction would be reached, depending on the area of ore, either mostly chalcopyrite.

1. A sequential treatment process for primary and secondary copper sulphide heap leaching of copper sulfide and mixed ores, which improves the thermodynamics and physicochemical balances and generates benefits on the metallurgical performance of the sequential treatment comprising the following stages:
mixing an ore with an acidic (unsaturated) brine; wherein the brine is added in conventional systems onto the ore that is belt conveyed for disposal in a dynamic leaching heap (1) to obtain an ore-brine mixture;
allowing the ore-brine mixture to stand on folders and in said dynamic leaching heap or primary leaching heap, effecting prolonged thermal rest comprising adding external heat by blowing heated saturated air into a bed (2);
subjecting to primary ore leaching by: oxidizing chemical (3), in which a conventional irrigation stage is carried out, where the irrigation is carried out first with an intermediate leach solution (ILS) with concentrations of chlorine greater than 40 g/L but less than 100 g/L and with Cu and Fe(T) concentration greater than 1 g/L and subsequently with refining solution with concentrations of chlorine greater than 40 g/L but less than 100 g/L;
carrying out a stage of excavation of leached ore (gravel) and adding saturated brine on belt (4), in which prior to its disposal in a permanent heap or secondary leaching heap of stage f), a over-saturated brine in chlorine is added on said gravel arranged on belt at a ratio of 0.5 to 3 kilograms of brine per ton of gravel or leached ore;
letting said gravel to rest in a permanent heap, generating a new rest without irrigation for a period of 45 to 90 days (5); and
subjecting said gravel (6) to a secondary leach, which is a oxidizing chemical leaching that contemplates a non-irrigation irrigation mode to favor aeration by natural convention in said permanent heap.

2. The sequential treatment process for primary and secondary copper sulphide heap leaching according to claim 1, wherein said brine of stage (1) is mixed until obtaining a moisture of the ore to be heaped between 5 to 10%.

3. The sequential treatment process for primary and secondary copper sulphide heap leaching according to claim 1, wherein said brine of stage (1) has a Cl concentration between 100 to 200 g/L.

4. The sequential treatment process for primary and secondary copper sulphide heap leaching according to claim 1, wherein said ore-brine mixture of stage (1) has a Cu(T) concentration of about 1.0 g/L.

5. The sequential treatment process for primary and secondary copper sulphide heap leaching according to claim 1, wherein said ore-brine mixture of stage (1) has a Fe(T) concentration above 1.0 g/L.

6. The sequential treatment process for primary and secondary copper sulphide heap leaching according to claim 1, comprising the addition in said stage (1) of sulfuric acid between 30 to 80% of the stoichiometric consumption of the ore.

7. The sequential treatment process for primary and secondary copper sulphide heap leaching according to claim 1, wherein said brine of stage (1) comprises chlorine salts selected from the group consisting of NaCl, KCl, MgCl₂, or any solid salt or brine containing high concentrations of Chlorine.

8. The sequential treatment process for primary and secondary copper sulphide heap leaching according to claim 1, wherein said mixture of stage (1) comprises process ILS solution, containing the dissolved Cu and Fe ions.

9. The sequential treatment process for primary and secondary copper sulphide heap leaching according to claim 1, wherein said mixture of stage (1) comprises concentrated sulfuric acid

10. The sequential treatment process for primary and secondary copper sulphide heap leaching according to claim 1, wherein, during thermal rest (2), saturated air is incorporated that is blown into the bed to maintain the temperature of the ore at values between 30° C. to 60° C.

11. The sequential treatment process for primary and secondary copper sulphide heap leaching according to claim 10, wherein the flow of saturated air in the thermal rest stage (2) must be greater than 0.5 Nm3/h-m², optionally greater than 1 Nm3/h-m².

12. The sequential treatment process for primary and secondary copper sulphide heap leaching according to claim 1, wherein the thermal rest time of stage (2) varies between 10 to 60 days depending on the type of ore.

13. The sequential treatment process for primary and secondary copper sulphide heap leaching according to claim 1, wherein the moisture of the heaped ore at thermal rest (2) is kept constant between 6 to 10%.

14. The sequential treatment process for primary and secondary copper sulphide heap leaching according to claim 1, wherein said thermal rest stage (2) is carried out in conjunction with a solution of high concentrations of Chlorine, 100 g/L<[Cl]<200 g/L.

15. The sequential treatment process for primary and secondary copper sulphide heap leaching according to claim 1, wherein said ILS solution of stage (3) ILS comprises Cu and Fe ions in solution so as to allow the leaching-ferric and cupric oxidation of the copper sulfides.

16. The sequential treatment process for primary and secondary copper sulphide heap leaching according to claim 1 wherein after the oxidizing chemical leaching under irrigation with ILS, it can be subjected to a new intermediate thermal rest.

17. The sequential treatment process for primary and secondary copper sulphide heap leaching according to claim 16, wherein the intermediate thermal rest time varies between 5 to 15 days depending on the type of ore.

18. The sequential treatment process for primary and secondary copper sulphide heap leaching according to claim 16, wherein said intermediate thermal rest stage is carried out in conjunction with a solution of high concentrations of chloride ion, [Cl]>25 g/L.

19. The sequential treatment process for primary and secondary copper sulphide heap leaching according to claim 16, wherein the intermediate thermal rest is carried out with heated air that is blown into the bed to maintain the temperature of the ore at values between 30° C. to 60° C.

20. The sequential treatment process for primary and secondary copper sulphide heap leaching according to claim 16, wherein the intermediate thermal rest can be carried out successively, interspersed with oxidizing chemical leaching stages, for as long as the ore is disposed on the dynamic heap.

21. The sequential treatment process for primary and secondary copper sulphide heap leaching according to claim 1, wherein said primary chemical ore-oxidant leaching (3) is carried out with continuous irrigation of ILS solution for a period of time between 20 to 60 days, followed by irrigation with refined solution comprising a continuous mode or an irrigation-non-irrigation mode.

22. The sequential treatment process for primary and secondary copper sulphide heap leaching according to claim 1, wherein said primary chemical-oxidizing ore leaching (3) ends with a drainage of between 3 to 10 days to decrease the moisture of the ore to a value close to 6%.

23. The sequential treatment process for primary and secondary copper sulphide heap leaching according to claim 1, wherein said over-saturated brine of stage (4) is prepared by mixing refining or process water and some chlorine salt so as to be over-saturated in chlorine at a Cl concentration between 300 to 600 g/l.

24. The sequential treatment process for primary and secondary copper sulphide heap leaching according to claim 25, wherein said Cl concentration is 500 g/l.

25. The sequential treatment process for primary and secondary copper sulphide heap leaching according to claim 1, wherein the gravel rest stage (5) is carried out for a time from 45 to 90 days.

26. The sequential treatment process for primary and secondary copper sulphide heap leaching according to claim 1, wherein the secondary gravel leaching stage (6) is performed in an irrigation-non-irrigation mode to allow a natural oxidation/aeration of the ore bed for a period of time between 30 to 300 days.

27. The sequential treatment process for primary and secondary copper sulphide heap leaching according to claim 1, wherein said secondary gravel leaching stage (6) contemplates natural aeration by intermittent irrigation-rest techniques.

28. The sequential treatment process for primary and secondary copper sulphide heap leaching according to claim 1, wherein said aeration of the heap is carried out by means of an aeration system that is arranged at the base of the heap and only above a drainage layer.
